(19) United States
(12) Patent Application Publication
(10) Pub. No.: US 2026/0241597 A1
(43) Pub. Date: Aug. 20, 2026

(54) FOOD CUTTING DEVICE

(71) Applicant: Lingqiu Shen, Ningbo (CN)

(72) Inventor: Lingqiu Shen, Ningbo (CN)

(21) Appl. No.: 19/541,569

(22) Filed: Feb. 17, 2026

(30) Foreign Application Priority Data
Feb. 17, 2025 (CN) 202520249935.7
Dec. 1, 2025 (CN) 202522553333.3
Dec. 1, 2025 (CN) 202522553352.6
Dec. 1, 2025 (CN) 202522553354.5

(51) Int. Cl. B26D 5/00; B26D 1/00; B26D 1/30; B26D 7/32

(52) U.S. Cl. CPC B26D 5/00; B26D 1/0006; B26D 1/30; B26D 7/32; B26D 2001/0033

(57) ABSTRACT

The present disclosure provides a food cutting device including a base; a cutting frame; a first cutter; a second cutter located downstream of the first cutter, the second cutter comprising a plurality of cutting blades spaced apart along the second direction, an adjusting member located downstream of the first cutter and the second cutter in the cutting direction, and movable relative to the first cutter along the third direction. The adjusting member includes at least one cutter feeding grooves, the at least one of the plurality of cutting blades is movable from the second position, then passes through the at least one cutter feeding groove in the third direction and toward the first cutter to the first position at which a tip portion of the at least one of the plurality of cutting blades is beyond the first cutter in the third direction.

### RELATED APPLICATIONS

This application claims the benefit of priority to Chinese Patent Application Number 202520249935.7 filed on Feb. 17, 2025, Chinese Patent Application Number 202522553352.6 filed on Dec. 1, 2025, Chinese Patent Application Number 202522553354.5 filed on Dec. 1, 2025 and Chinese Patent Application Number 202522553333.3 filed on Dec. 1, 2025, in the China National Intellectual Property Administration. The entire contents of the above-identified application are hereby incorporated by reference.

### TECHNICAL FIELD

The present disclosure relates to the technical field of food processing equipment, and in particular, to a food cutting device.

### BACKGROUND

An important part of food processing process for meat and vegetables is cutting raw food into desired shapes. At present, a food cutting process in the industry may be finished by manual cutting or cutting via a food cutting device. The food cutting device has been widely used due to its convenience. However, when we use the food cutting device to cut the raw food into strip shapes, it is difficult to cut the raw food horizontally in one go, so that the raw food can not completely separated, the strip portions are connected together. Such deficiencies may seriously affect user experience, therefore, it is in need of improvement.

### BRIEF DESCRIPTION OF DRAWINGS

Implementations of the present disclosure will now be described, by way of embodiment, with reference to the attached figures.

FIG. 1 illustrates a perspective structural view of a food cutting device according to an embodiment of the present disclosure.

FIG. 2 illustrates a perspective structural view of an embodiment of a partial component of the food cutting device shown in FIG. 1.

FIG. 3 illustrates an enlarged schematic view of area A in FIG. 2.

FIG. 4 illustrates a front view of the partial component of the food cutting device shown in FIG. 2.

FIG. 5 illustrates a side view of the partial component of the food cutting device shown in FIG. 2.

FIG. 6 illustrates an exploded view of the partial component of the food cutting device shown in FIG. 2, viewed from another angle.

FIG. 7 illustrates a perspective structural view of the partial component of the food cutting device shown in FIG. 2, viewed from another angle.

FIG. 8 illustrates a perspective structural view of an embodiment of a second housing of the food cutting device shown in FIG. 1.

FIG. 9 illustrates a perspective structural view of an embodiment of an ejection component of the food cutting device shown in FIG. 8.

FIG. 10 illustrates a perspective structural view of the partial component of the food cutting device shown in FIG. 2, with a second cutter located at a storage position according to an embodiment of the present disclosure.

FIG. 11 illustrates a cross-sectional view of the partial component of the food cutting device shown in FIG. 2, with the second cutter located at the storage position according to an embodiment of the present disclosure.

FIG. 12 illustrates a perspective structural view of the partial component of the food cutting device shown in FIG. 2, with a first cutting blade of the second cutter in a cutting position according to an embodiment of the present disclosure.

FIG. 13 illustrates a perspective structural view of the partial component of the food cutting device shown in FIG. 2, with the first cutting blade and a second cutting blade of the second cutter both located at the cutting position according to an embodiment of the present disclosure.

FIG. 14 illustrates a cross-sectional view of the partial component of the food cutting device shown in FIG. 2, with the second cutter located at the cutting position according to an embodiment of the present disclosure.

FIG. 15 illustrates a schematic view of a positional relationship between a first cutter and the second cutter of the food cutting device shown in FIG. 1.

FIG. 16 illustrates another schematic view of the positional relationship between the first cutter and the second cutter of the food cutting device shown in FIG. 1.

FIG. 17 illustrates an exploded view of the second cutter of the food cutting device shown in FIG. 1.

FIG. 18 illustrates a state view of an embodiment of a first cutter holder and an embodiment of a second cutter holder of the food cutting device shown in FIG. 1, the first cutter holder and the second cutter holder are engaged with each other.

FIG. 19 illustrate a state view of the first cutter holder and the second cutter holder of the food cutting device shown in FIG. 1, the first cutter holder and the second cutter holder are separated from each other.

FIG. 20 illustrates a perspective structural view of the second cutter shown in FIG. 17, viewed from another angle.

FIG. 21 illustrates a perspective structural view of another embodiment of a partial component of the food cutting device shown in FIG. 1.

FIG. 22 illustrates an enlarged schematic view of area B in FIG. 21.

FIG. 23 illustrates a perspective structural view of an embodiment of an control assembly and the second cutting blade of the food cutting device shown in FIG. 1.

FIG. 24 illustrates a perspective structural view of an embodiment of a push rod in FIG. 23.

### DETAILED DESCRIPTION

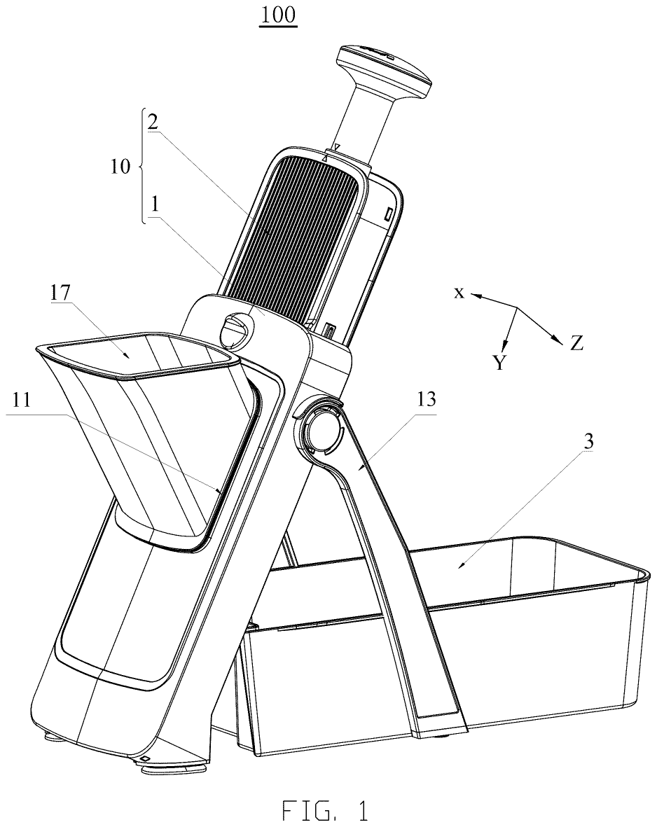

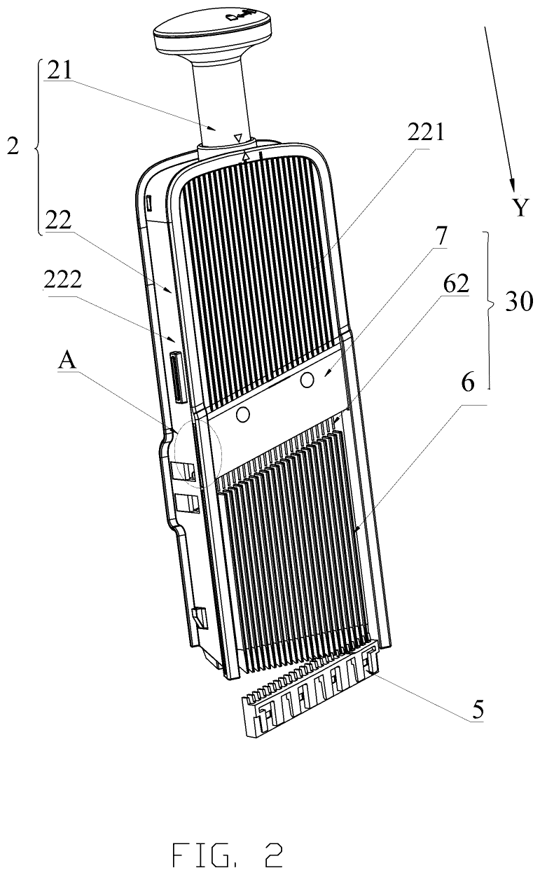

Referring to FIGS. 1 and 2, the present disclosure discloses a food cutting device 100, which includes a housing 10, a cutting mechanism 30 and a feeding member 17. The cutting mechanism 30 and the feeding member 17 are attached to the housing 10. The cutting mechanism 30 is configured to cut food material, such as meat. The feeding member 17 is disposed corresponding to the cutting mechanism 30 and configured to receive and contain the food material.

For the convenience of the following description, referring to FIG. 1, a width direction of the food cutting device 100 is defined as a direction X (a second direction), a length direction of the food cutting device 100 is defined as a direction Y (a first direction), a thickness direction of the food cutting device 100 is defined as a direction Z (a third direction), a front side of the housing 10 is defined as a forward side, and an opposite side of the front side is defined as a rear side. In this embodiment, a cutting direction of the food cutting device 100 is parallel to the direction Y.

The housing 10 includes an opening 11 in the forward side thereof. The feeding member 17 is detachably attached to the opening 11. The food material can enter the internal of the housing 10 after being placed into the feeding member 17, and thereby being cut by the cutting mechanism 30. A container 3 can be placed at the rear side of the housing 10 and below the discharging port for contain the cut food. In an embodiment, the container 3 may be a box.

Referring to FIGS. 1 and 2, the housing 10 includes a first housing 2 and a second housing (an example of base or housing) 1, the first housing 2 is detachably and movably received in the second housing 1. The first housing is capable of reciprocating relative to the second housing 1 along the cutting direction (direction Y).

Referring to FIGS. 1, 2 and 4 to 6, the first housing 2 includes a handle portion 21, a cutting frame 22 and a mounting member 23. The handle portion 21 is disposed at a top end of the cutting frame 22. The handle portion 21 is convenient for manual operation, so that a user can push and pull the first housing 2 to reciprocate relative to the second housing 1 along the direction Y, thereby cutting the food material. In addition, the top end refers to an end of the food cutting device 100 located at an upper side, and a bottom end refers to an end of the food cutting device 100 located at a lower side when the food cutting device 100 is in a use state.

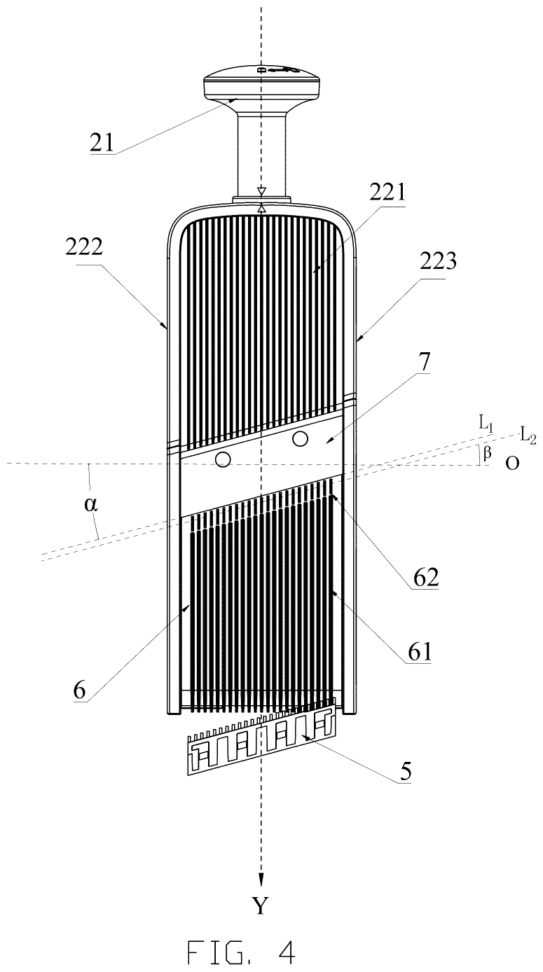

Referring to FIG. 2 and FIG. 4, the cutting frame 22 includes a first side wall 221, a second side wall 222 and a third side wall 223. The second side wall 222 and the third side wall 223 are opposite to each other and extend along the direction Y. Two opposite sides of the first side wall 221 are connected to one side of the second side wall 222 and one side of the third side wall 223, respectively, thereby forming a receiving cavity (not shown) for receiving at least a part of the cutting mechanism 30.

In the present disclosure, the first side wall 221 is located at an upper side of the cutting frame 22.

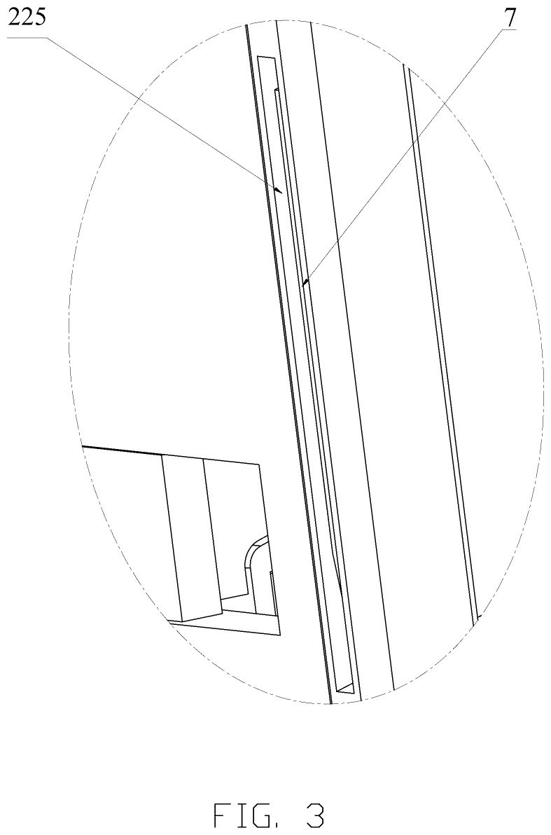

Referring to FIG. 3, each of the second side wall 222 and the third side wall 223 has an inner surface facing the receiving cavity, a positioning groove 225 is formed in each inner surface and configured to receive an end of a first cutter 7 described below, so as to limit the first cutter 7 in the direction Y and the direction Z, ensuring structural stability thereof.

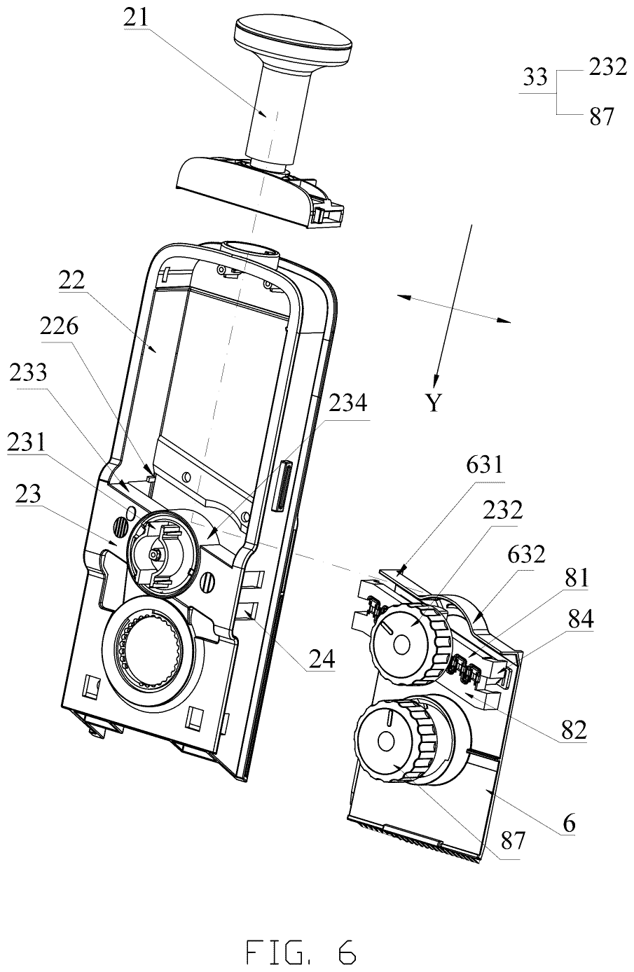

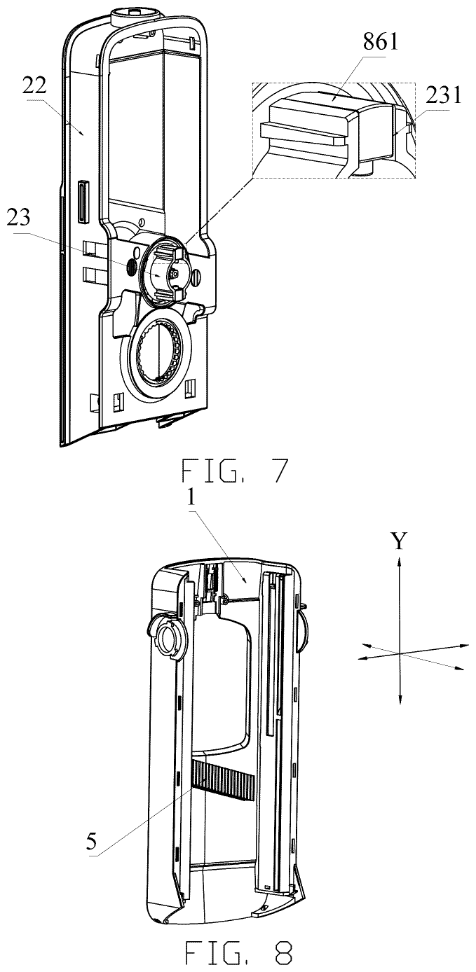

Referring to FIGS. 6 and 7, the mounting member 23 is disposed at a rear side of the cutting frame 22 and configured to mount the cutting mechanism 30. A receiving groove 231 is defined in the mounting member 23. In some embodiments, the mounting member 23 and the cutting frame 22 may be an integrated structure.

Referring to FIG. 1, the second housing 1 is configured to be placed on a horizontal plane to support the first housing 2. Referring to FIG. 1, the second housing 1 includes a pair of support frames 13 rotatably disposed on two opposite sides of the second housing 1, so as to support the second housing 1 on the plane.

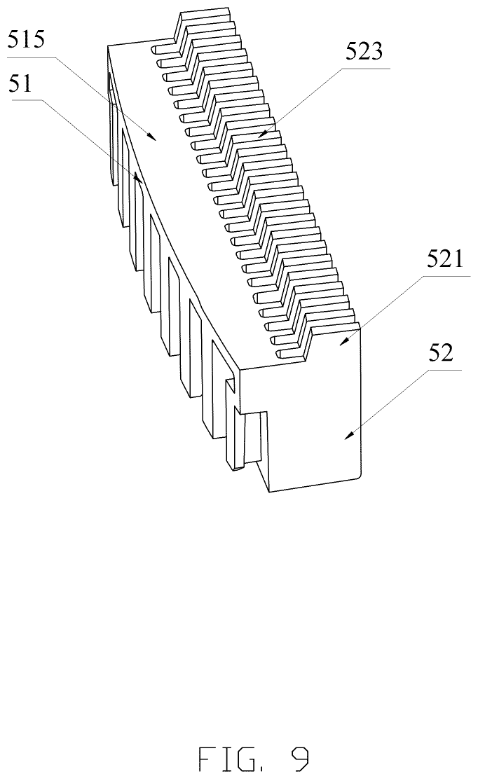

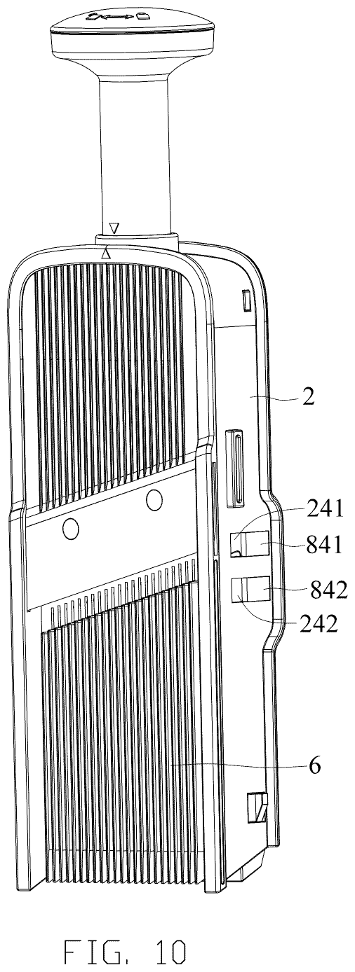

Referring to FIGS. 8 and 9, the second housing 1 further includes an ejection component 5 arranged at a side of the second housing 1 facing the first housing 2, the ejection component 5 includes a connecting plate 51 connected to the second housing 1 and a plurality of ridges 52 integrally formed with the connecting plate 51 and protruding in a direction away from the second housing 1. Each ridge 52 is strip-shaped and extends along the direction Y, the plurality of ridges 52 are arranged at intervals in the direction X.

In addition, a top edge 523 of the ridge 52 is higher than an upper end surface 515 of the connecting plate 51 in the direction Y, so that an avoidance area is formed at an upper end portion of the ejection component 5. Therefore, the ridge 52 can effectively eject the food material while avoiding impact and shearing damage inflicted on the connecting plate 51 by the first cutter 7 and the second cutter 8 of the food cutting device 100, thereby the ejection component 5 and cutting edges of cutter blades are prevented from being damaged, and ensuring smooth and uninterrupted cutting operations.

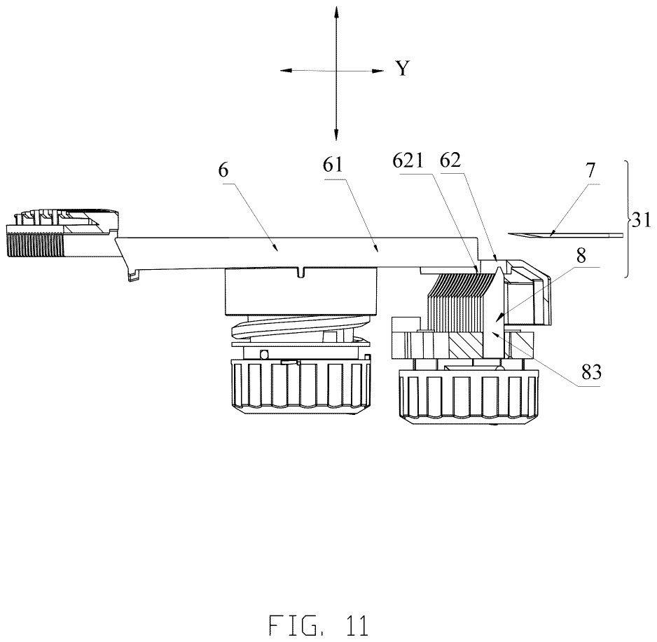

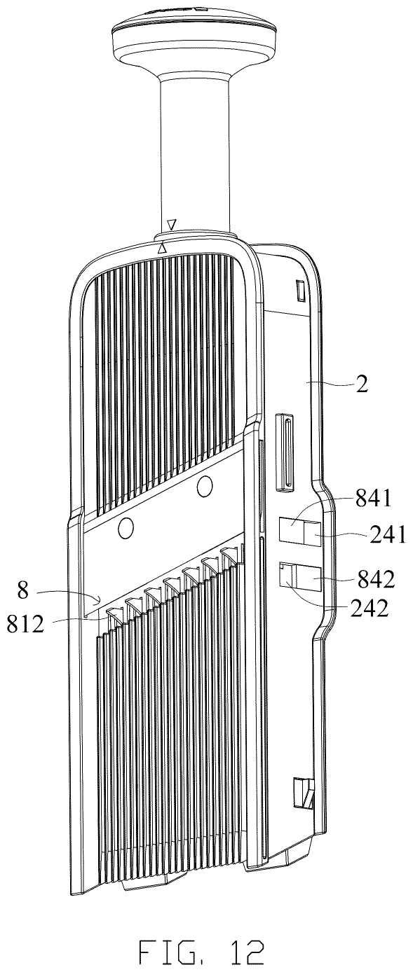

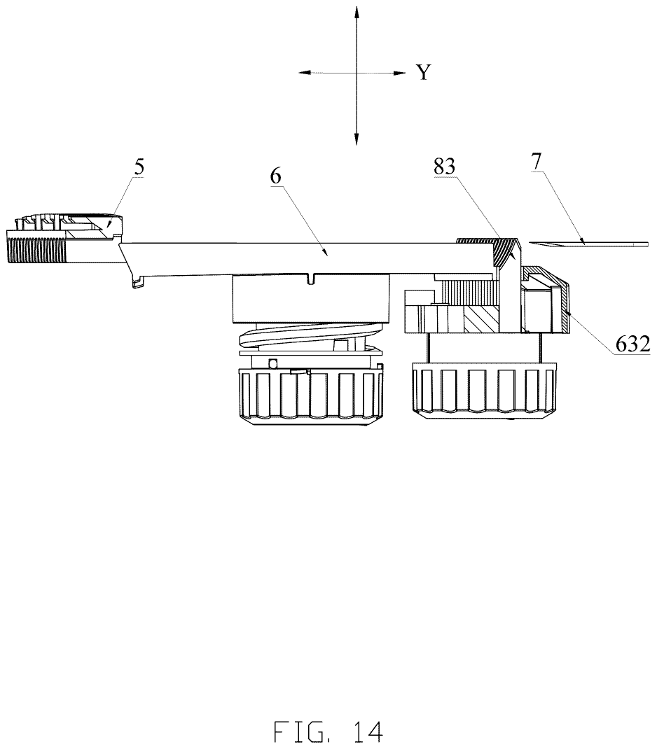

Referring to FIGS. 11 and 14, the cutting mechanism 30 is disposed on the first housing 2 and is movable with the first housing 2 and relative to the second housing 1 along the cutting direction. The cutting mechanism 30 includes a blade assembly 31, an adjusting member 6 and an control assembly 33.

The blade assembly 31 includes the first cutter 7 and a second cutter 8 which are mounted on the cutting frame 22.

Referring to FIGS. 4, 11 and 14, the first cutter 7 is disposed at the first side wall 221 of the cutting frame 22 and is kept coplanar or parallel with the first side wall 221. In addition, a component of an extending direction of a cutting edge of the first cutter 7 is in the width direction (the direction X) of the cutting frame 22.

The second cutter 8 is located downstream of the first cutter 7 in the cutting direction (the direction Y). The second cutter 8 includes a plurality of cutting blades 83 spaced apart along the direction X, and a blade face of each cutting blade 83 extends along the thickness direction (the direction Z) of the cutting frame 22 and the blade face of each cutting blade 83 is perpendicular to the a blade face of the first cutter 7. Each cutting blade 83 includes a tip portion 830 located at one side of the cutting blade 83 and configured to cut food material.

In one embodiment, each cutting blade 83 is telescopically movable along the direction Z and capable of switching between a storage position (second position) and a cutting position (first position). Referring to FIGS. 10 and 11, when the plurality of cutting blades 83 move to a lowest end of a stroke range of the second cutter 8 in the direction Z, the plurality of cutting blades 83 are located at the storage position, the second cutter 8 does not cut food material, and only the first cutter 7 slices the food material, so as to cut the food material into slices one by one. referring to FIGS. 12 to 14, when the plurality of cutting blades 83 moves to a highest end of the stroke range of the second cutter 8 in the direction Z, the cutting blades 83 are located at the cutting position, the second cutter 8 cooperate with the first cutter 7 to cut the food material, so as to cut the food material into strips or shreds.

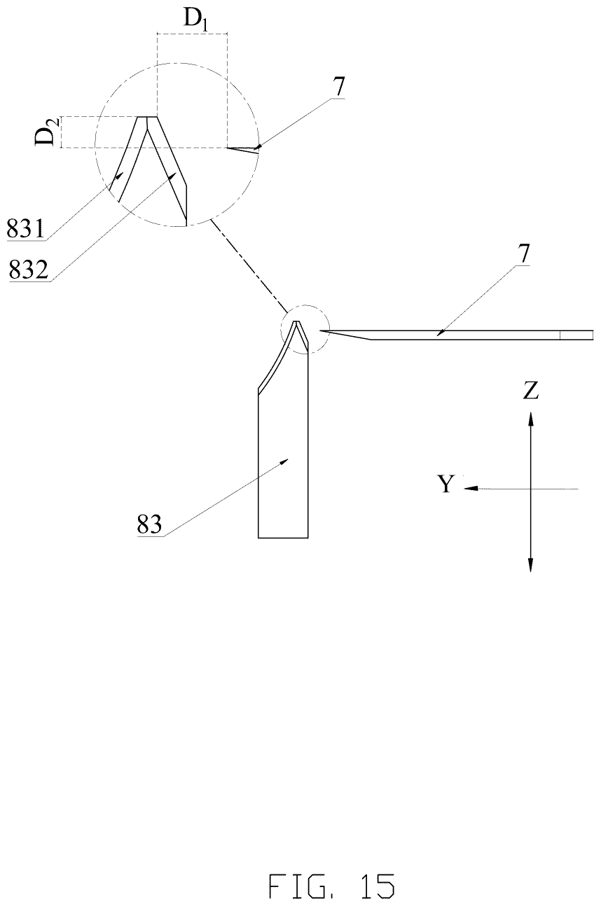

In the present embodiment, referring to FIGS. 14 and 15, when the cutting blades 83 move to the highest end of the stroke range of the second cutter 8 in the thickness direction, the cutting blades 83 are located at the cutting position, and at least a part of the cutting blade 83 is located higher than an tip portion of the first cutter 7 in the direction Z, so that a gap D₂ in the direction Z is formed between the tip portion 830 of the cutting blade 83 and the tip portion of the first cutter 7.

When at least a part of the tip portion 830 of the cutting blade 83 is located higher than the tip portion of the first cutter 7 in the direction Z, the height difference is formed between the tip portion of the first cutter 7 and the at least a part of the tip portion 830, so that the second cutter 8 forms relatively deep strip-shaped grooves in the contacted food material, with the roots of the strip-shaped grooves positioned above the cutting surface of the first cutter 7. Therefore, when cutting the food material, the first cutter 7 moving downward in the direction Y can transversely cut the part of the food material, thereby cutting the food material into strips and completing the cutting of the food material.

Further, a gap D₁ in the direction Y is formed between a tip portion of the first cutter 7 and the tip portion 830 of the cutting blade 83. Referring to FIGS. 4 and 15, the projection of the outer edge of the cutting edge of the first cutter 7 in the direction Z is a straight line L₁, the projection of the tip portion 830 of a single cutting blade 83 in the direction Z is a point, and the distance from the point to L₁ is D₁. the projections of the tip portions 830 of a plurality of cutting blades 83 in the direction Z can be connected into a straight line L₂, and then the distance between L₁ and L₂ is D₁. The spacing between projections in the present disclosure refers to the distance between points, lines or surfaces formed by projections in the same plane in a certain direction.

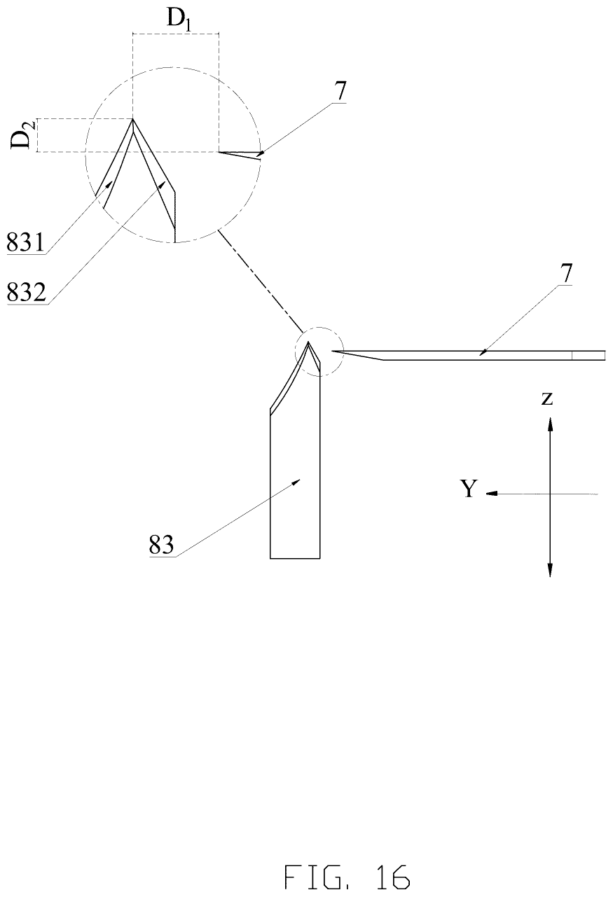

Referring to FIG. 15, when each of the tip portions 830 of the cutting blades 83 has two or more vertices, D₁ refers to the spacing between an vertex of the cutting blade closest to the first cutter 7 and the projection of the outer edge of the cutting edge of the first cutter 7 in the direction Z, referring to FIG. 16, when each of the tip portions 830 of the cutting blades 83 has a unique vertex, D₁ refers to the spacing between the unique vertex and the projection of the outer edge of the cutting edge of the first cutter 7 in the direction Z.

Cutting tests were performed on the blade assemblies 31 with different values of D₁ and D₂ to screen a preferred embodiment range, and the cutting test conditions are as follows:

a. Test Preparation:

In the production of the food cutting device 100, a plurality of production groups are divided according to different values of D₁ and D₂ (the values of D₁ and D₂ are adjusted as shown in Tables 1 and 2 during production). Except for the different values of D₁ and D₂, all production materials and assembly steps are the same. When producing products with different values of D₁, D₂ of the products is uniformly set to 1.3 mm, when producing products with different values of D₂, D₁ of the products is uniformly set to 2.4 mm.

b. Counting Rule:

One cutting is defined as one “downward cutting-retraction” action completed by the blade assembly 31, and cutting objects are sweet potatoes (hard food material) of the same origin and variety, the cutting experience (smooth, jerky or jammed), and the notch depth (mm) of the first cutter after 30,000 cuttings of each group with different values of D₁ are counted, the food cutting rate, the retraction distance ratio of the blade assembly 31, and the cutting experience (smooth, jerky or jammed) of each group with different values of D₂ after 30,000 cuttings are counted.

c. Standard Setting:

The operation experience is divided into three types: “smooth”, “jerky” and “jammed”. “Smooth” means that when cutting food material, the tester pushes and pulls the handle portion of the food cutting device 100 without obvious jamming or jerking during the pushing and pulling process, and the food material can be cut smoothly in each pushing and pulling. “Jerky” means that during the food cutting process, the cutter blade is not very sharp, and the cutting feels laborious. “Jammed” means that when cutting food material, the tester pushes and pulls the handle portion of the food cutting device 100 with obvious jamming or difficulty in smooth resetting during the pushing and pulling process, requiring manual cleaning of food material jammed between the cutting blades or pulling force to retract the cutter to the initial cutting position, resulting in a poor cutting experience.

$$A jamming rate calculation formula is : ( number of jamming occurrences \div total number of cuttings ) \times 100 \% .$$

$$A food cutting rate calculation formula is : ( number of complete food cuttings \div total number of cuttings ) \times 100 \% .$$

A retraction distance ratio calculation formula of the blade assembly 31 is: (retraction distance of the blade after complete downward cutting÷total retraction stroke length)×100%; when the food material to be cut are pressed with a normal force to make the cutting surface of the food material to be cut attach to the blade assembly 31, and the area of the food material to be cut is approximately the same as that of the feeding port of the food cutting device 100, after the blade assembly 31 is cut downward, it is completely retracted to the initial position driven by the elastic reset member of the food cutting device 100 by itself, and then the retraction distance ratio of the blade assembly 31 is 100%.

TABLE 1
Notch depth of the first cutter and cutting experience
of each D₁ group after 30,000 cutting tests

| | | Notch depth of the first cutter | |
|---|---|---|---|
| Group | D₁ (mm) | (mm) | Cutting experience |
| 1 | 0.8 | A large number of notches | Obvious jerking |
| | | with large depth (0.01-0.02) | |
| 2 | 0.9 | A small number of notches | Slight jerking |
| | | with small depth (<0.01) | |
| 3 | 1.0 | Very few notches with small | Minimal jerking |
| | | depth (<0.01) | |
| 4 | 1.2 | Extremely few notches with | Smooth |
| | | minimal depth | |
| 5 | 1.4 | No notches | Smooth |
| 6 | 1.6 | No notches | Smooth |
| 7 | 2.0 | No notches | Smooth |
| 8 | 2.4 | No notches | Smooth |
| 9 | 2.8 | No notches | Smooth |
| 10 | 3.2 | No notches | Jamming rate ≤5% |
| 11 | 3.6 | No notches | Jamming rate ≤10% |
| 12 | 4.0 | No notches | Jamming rate ≤15% |
| 13 | 4.4 | No notches | Jamming rate ≤22% |
| 14 | 4.6 | No notches | Jamming rate ≤30% |
| 15 | 4.8 | No notches | Jamming rate >35% |
| 16 | 5.0 | No notches | Jamming rate >50% |

Analysis of Table 1 is as follows. When D₁ is less than 1.0 mm (D₁<1.0 mm), the cutting blades 83 of the second cutter 8 are prone to tilt due to the resistance of food material and impact the first cutter 7 during cutting, creating notches on the cutting edge of the first cutter 7, and the smaller D₁ is, the greater the number of notches and the larger the depth, which affects the sharpness of the first cutter 7, causes serious damage to the cutting edge of the first cutter 7 in a short use time, gradually increases the jerking feeling during cutting, and seriously shortens a service life of the first cutter 7. Due to the sufficiently small D₁, food material will not be jammed into the spacing between the first cutter 7 and the second cutter 8, and the cutting experience is relatively smooth at the beginning of the test, but as the number of cuttings increases, the blade assembly 31 is damaged and blunted, the resistance during downward cutting of food material increases significantly, the jerking feeling is gradually generated, and the cutting experience is gradually deteriorated.

When D₁ is equal to 1.0 mm (D₁=1.0 mm), although the cutting blades 83 of the second cutter 8 may occasionally collide with the cutting edge of the first cutter 7, the probability of notches on the first cutter 7 is significantly reduced, the notch depth is extremely small, the cutting experience is still good, and the jerking feeling is not obvious.

When D₁ is greater than 1.0 mm (1.0 mm<D₁), even if the cutting blades 83 of the second cutter 8 incline due to the resistance of food material during cutting, the chance of impacting the first cutter 7 is significantly reduced or even eliminated, so there are basically no or very few notches on the first cutter 7. When D₁ is greater than or equal to 1.6 mm and less than or equal to 2.8 mm (1.6 mm≤D₁≤2.8 mm), whether cutting soft food material (cucumbers, potatoes) or hard food material (sweet potatoes), food material are not easily jammed into the spacing between the first cutter 7 and the second cutter 8, the cutting experience is very smooth, and at the same time, damage and jerking caused by mutual interference and collision between the first cutter 7 and the second cutter 8 are avoided, ensuring the service life of the product and smooth cutting. When D₁ is greater than 2.8 mm (2.8 mm<D₁), the spacing between the first cutter 7 and the second cutter 8 becomes larger and larger, food material are gradually jammed into the gap between the first cutter 7 and the second cutter 8, and the jamming rate increases with the increase of D₁. When D₁ is greater than 4.6 mm (4.6 mm<D₁), the jamming rate is greater than 30%, food material are often jammed into the gap of D₁, the cutting experience is seriously deteriorated, and the blade assembly 31 cannot play a role in convenient cutting, therefore the range where D₁ is greater than 4.6 mm (4.6 mm<D₁) is not considered in product design. In summary, D₁ falls within a range of 1.0 mm to 4.6 mm (1.0 mm≤D₁≤4.6 mm), the cutter blade assembly achieves basic cutting performance and provides an excellent cutting experience.

TABLE 2
Food cutting rate, retraction distance ratio and cutting
experience of each D₂ group after 30,000 tests

| | | | Retraction distance | Cutting |
|---|---|---|---|---|
| Group | D₂ (mm) | Food cutting rate | ratio | experience |
| 1 | 0.5 | ≤50% when cutting food | ≤50% when cutting | ≤50% when |
| | | into thick strips (thickness | food into thick strips | cutting food into |
| | | about 5-8 mm), not | (thickness about 5- | thick strips |
| | | considered for selection | 8 mm), not considered | (thickness about |
| | | | for selection | 5-8 mm), not |
| | | | | considered for |
| | | | | selection |
| 2 | 0.6 | >65% | >99% | Smooth |
| 3 | 0.7 | >95% | >99% | Smooth |
| 4 | 0.8 | >95% | >99% | Smooth |
| 5 | 0.9 | >95% | >99% | Smooth |
| 6 | 1.0 | >99% | >99% | Smooth |
| 7 | 1.1 | >99% | >99% | Smooth |
| 8 | 1.2 | >99% | >99% | Smooth |
| 9 | 1.3 | >99% | >99% | Smooth |
| 10 | 1.4 | >99% | >99% | Smooth |
| 11 | 1.5 | >99% | ≈95% | Slight jamming |
| 12 | 1.6 | >99% | ≈85% | Slight jamming |
| 13 | 1.7 | >99% | ≈78% | Slight jamming |
| 14 | 1.8 | >99% | ≥65% | Severe jamming |
| 15 | 1.9 | >99% | <40% | Severe jamming |
| 16 | 2.0 | >99% | <10% | Severe jamming |

Analysis of Table 2 is as follows. When D₂ is less than 0.6 mm (D₂<0.6 mm), the height difference between each of the tip portions 830 of the cutting blades 83 of the second cutter 8 and the tip portion of the first cutter 7 in the direction Z is extremely small, the root of the strip-shaped gap cut on the food material by the second cutter 8 is very adjacent to the cutting surface of the first cutter 7, and during cutting, the extrusion force of the food material to be cut itself slightly lifts the first cutter 7 upward in the direction Z, further reducing the height difference between the tip portions 830 of the cutting blades 83 and the first cutter 7, resulting in a common phenomenon of “uncut” food material and failure to cut the food material into strips. For example, when D₂ is equal to 0.5 mm (D₂=0.5 mm), when it is necessary to cut food material into thin strips, the resistance of the food material itself is small, the degree of the first cutter 7 being lifted upward in the direction Z by the food material is small, and the cutting rate can reach more than 60%, but when it is necessary to cut thick strips (thickness about 5-8 mm), the extrusion force of the food material on the first cutter 7 becomes large, the degree of the first cutter 7 being lifted upward in the direction Z is large, resulting in a food cutting rate ≤50%.

When D₂ is greater than or equal to 1.6 mm (0.6 mm≤D₂), the food cutting rate is significantly improved regardless of whether the food material need to be cut into thin strips or thick strips, which can effectively overcome the problem of inability to cut into strips caused by the food material lifting the first cutter 7 upward. When D₂ is greater than or equal to 0.7 mm (0.7 mm≤D₂), the cutting rate of sweet potatoes can reach more than 95%, and cucumbers (soft food material) are added for cutting tests, and the cutting rate of cucumbers can reach 100% (compared with hard food material, soft food material have smaller extrusion force on the blade assembly 31 and are easier to cut). When D₂ is greater than or equal to 1.0 mm (1.0 mm≤D₂), the cutting rate of hard food material is >99% regardless of whether the food material need to be cut into thin strips or thick strips, but when D₂ is greater than 1.4 mm (1.4 mm<D₂), as the height difference between the tip portions 830 of the cutting blades 83 of the second cutter 8 and the tip portion of the first cutter 7 in the direction Z becomes larger and larger, when the blade assembly 31 retracts, the tip portions 830 of the second cutting blade 8 will cut into the food material more, resulting in greater retraction resistance of the food material to the second cutting blade 8, the elastic reset member of the food cutting device 100 itself cannot provide sufficient retraction power to drive the blade assembly 31 to automatically retract to the initial position, and manual intervention is required to help the blade assembly 31 reset, resulting in obvious jamming feeling during manual cutting and poor cutting experience. Therefore, 1.0 mm≤D₂≤1.4 mm is preferred.

When D₂ is equal to 1.8 mm (D₂=1.8 mm), there are many jamming phenomena, but it is still tolerable and usable. However, when D₂ is greater than 1.8 mm (1.8 mm<D₂), the automatic retraction distance ratio of the food cutting device 100 is less than 40%, and manual force is required to assist the reset of the blade assembly 31 each time, resulting in an extremely poor cutting experience that consumers generally cannot accept. Therefore, 0.6 mm≤D₂≤1.8 mm is limited, and within the range of 0.6 mm≤D₂≤1.8 mm, the food cutting device 100 can ensure a high cutting rate for various soft and hard food material, and has a good cutting experience whether cutting thick slices or thin slices.

In one embodiment, the blade assembly 31 is configured such that D₁=1.8 mm and 1.0 mm≤D₂≤1.4 mm.

In one embodiment, the blade assembly 31 is configured such that D₁=2.1 mm and 1.0 mm≤D₂≤1.4 mm.

In one embodiment, the blade assembly 31 is configured such that D₁=2.2 mm and 1.0 mm≤D₂≤1.4 mm.

In one embodiment, the blade assembly 31 is configured such that D₁=2.3 mm and 1.0 mm≤D₂≤1.4 mm.

In one embodiment, the blade assembly 31 is configured such that D₁=2.4 mm and 1.0 mm≤D₂≤1.4 mm.

In one embodiment, the blade assembly 31 is configured such that D₁=2.5 mm and 1.0 mm≤D₂≤1.4 mm.

In one embodiment, the blade assembly 31 is configured such that D₁=2.6 mm and 1.0 mm≤D₂≤1.4 mm.

In one embodiment, the blade assembly 31 is configured such that D₁=2.8 mm and 1.0 mm≤D₂≤1.4 mm.

In one embodiment, the blade assembly 31 is configured such that 1.6 mm≤D₁≤2.8 mm and D₂=1.1 mm.

In one embodiment, the blade assembly 31 is configured such that 1.6 mm≤D₁≤2.8 mm and D₂=1.2 mm.

In one embodiment, the blade assembly 31 is configured such that 1.6 mm≤D₁≤2.8 mm and D₂=1.3 mm.

In one embodiment, the blade assembly 31 is configured such that 1.6 mm≤D₁≤2.8 mm and D₂=1.4 mm.

In one embodiment, referring to FIG. 4, an imaginary connecting line defined by connecting the projections of the tip portions 830 of the plurality of cutting blades 83 in the direction Z is a straight line L₂, the projection of the outer edge of the cutting edge of the first cutter 7 in the direction Z is a straight line L₁, L₁ is parallel to L₂. An included angle α between L₁ and an axis O of the first housing in the is an acute angle. The axis O is parallel to the direction X. L₁ is parallel to L₂, the included angle between L₁ and the axis O is α, an included angle between L₂ and the axis O is β, and α=β, so as to ensure that the first cutter 7 and the second cutter 8 cooperate perfectly and synergistically during food cutting. Since the direction X is perpendicular to the direction Y, when the cutter blade cuts downward along the direction Y, a part of the cutting edges of the first cutter 7 and the second cutter 8 which are obliquely distributed relative to the axis O will cut into the food material first, and the remaining cutting edges will cut into the food material step by step in sequence, thereby reducing the cutting resistance.

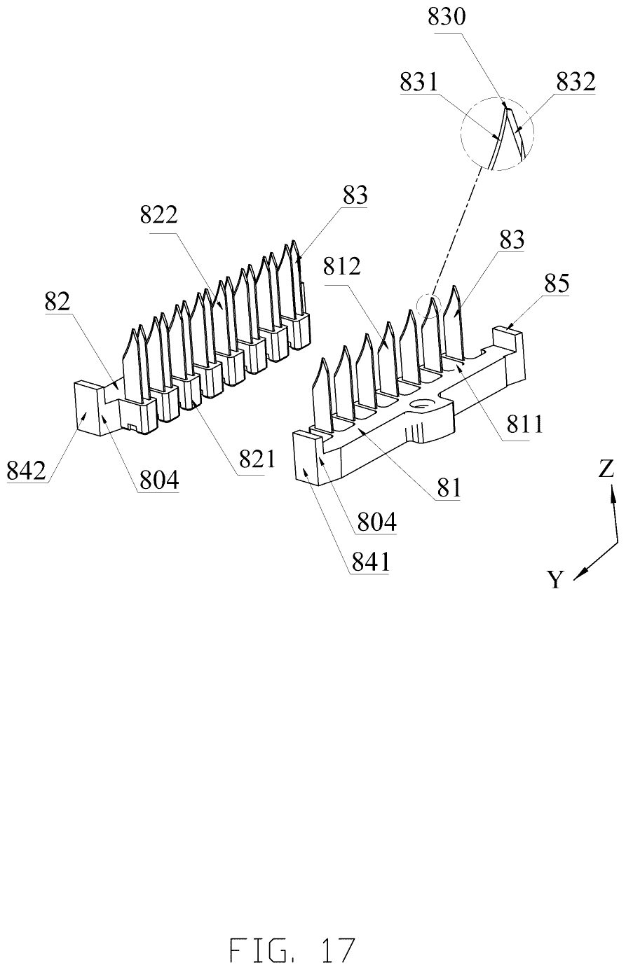

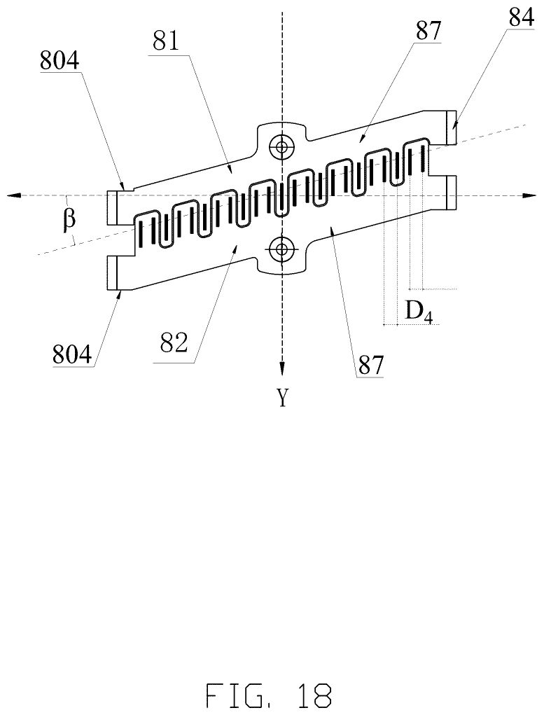

In one embodiment, referring to FIGS. 17 and 18, the second cutter 8 includes a first cutter holder 81 and a second cutter holder 82, the first cutter holder 81 includes a plurality of first protrusions 811 arranged on the first cutter holder 81 and arranged at intervals along the direction X, and a plurality of first cutting blades 812, each first protrusion 811 is provided with one of the cutting blade 812. The second cutter holder 82 comprises a plurality of second protrusions 821 arranged on the second cutter holder 82 and arranged at intervals along the direction X, and a plurality of second cutting blades 822, each second protrusion 821 is provided with at least two second cutting blades 822 arranged at intervals. The first cutter holder 81 and the second cutter holder 82 are engaged with each other via a concave-convex engagement of the plurality of first protrusions 811 and the plurality of second protrusions 821, and the first cutter holder 81 and the second cutter holder 82 are slidable relative to each other in the direction Z. By arranging the cutter holder as a structure in which the first cutter holder 81 and the second cutter holder 82 are engaged with each other and slidable relative to each other in the direction Z, the combination and distribution of the cutting blades 83 can be flexibly adjusted according to actual cutting requirements.

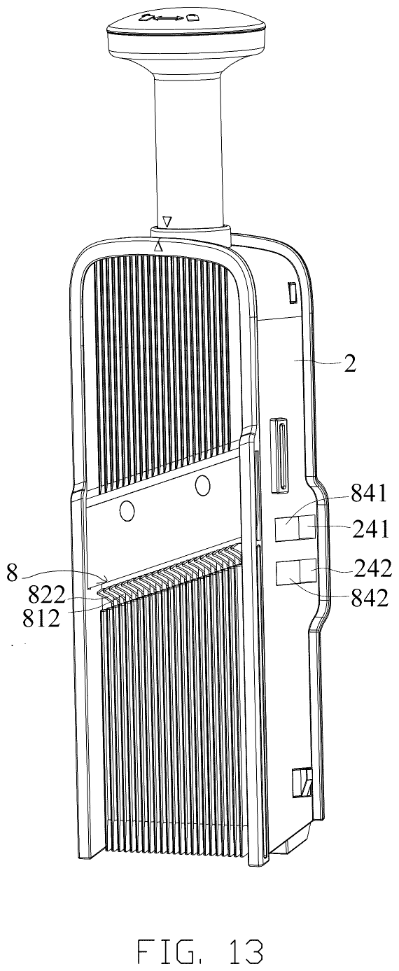

Referring to FIG. 12, when the food material needs to be cut into strips, the first cutter holder 81 can drive the first cutting blades 812 to move to the cutting position, so that the relatively sparsely distributed first cutting blades 812 on the first cutter holder 81 cooperate with the first cutter 7 to cut the food material into strips. Referring to FIG. 13, when the food material needs to be cut into shreds, the first cutter holder 81 and the second cutter holder 82 drive the first cutting blades 812 and the second cutting blades 822 to move to the cutting position, and the first cutter holder 81 and the second cutter holder 82 engage with each other, so that the cutting blades 83 are densely distributed and cooperate with the first cutter 7 to cut the food material into shreds. This design greatly improves the applicability and flexibility of the blade assembly 31 and can meet the requirements of different food material and different cutting precisions. At the same time, the concave-convex engagement between the plurality of first protrusions 811 and the plurality of second protrusions 821 can ensure the stability and reliability of the first cutter holder 81 and the second cutter holder 82 during fitting, and prevents loosening or jamming during relative sliding along the direction Z, thereby ensuring a smooth cutting process. The first cutting blades 812 and the second cutting blades 822 are collectively referred to as cutting blades 83.

Further, in one embodiment, referring to FIG. 17, each cutting blade 83 includes a front cutting edge 831 and a rear cutting edge 832 connected to the front cutting edge 831, the front cutting edge 831 is located on a side facing away from the first cutter, the rear cutting edge 832 is located on a side facing toward the first cutter 7 when the second cutter is located in the cutting position, and an included angle is formed between the front cutting edge 831 and the rear cutting edge 832. A length of the front cutting edge 831 of the cutting blade 83 is greater than a length of the rear cutting edge 832. The double-sided cutting edge design can reduce the retraction resistance of the cutting blade 83, so that the cutting blade 83 can retract smoothly in the reverse direction after cutting food material forward in the direction Y. In order to fully cut the food material, the length of the front cutting edge 831 of the cutting blade 83 is relatively large. As for the rear cutting edge 832 of the cutting blade 83, it only needs to be formed such that a portion of the rear cutting edge 832 extends beyond the tip portion of the first cutter 7 when the second cutter 8 is located in the cutting position. Thus, the length of the rear cutting edge 832 is relatively small, which does not affect the strength of the front cutting edge 831 and also facilitates the machining of the rear cutting edge 832.

The limiting assembly (limiting mechanism) 40 is cooperating with the second cutter 8 and configured to control a limit distance of the cutting blades 83 in the direction Z. The limiting assembly 40 includes at least one guide portion 84 for guiding the second cutter 8 to move in the direction Z and at least one limiting portion 24 corresponding with the at least one guide portion 84 for restrict a movement of the second cutter 8 in the direction Z, each of the at least one guide portion 84 is disposed at the cutter holder. Each of the at least one limiting portion 24 is disposed on the cutting frame 22, the at least one guide portion 84 is received in the at least one limiting portion 24, and slidable along the direction Z, and in the cutting direction Y, two inner side walls of the limiting portion 24 abut against and limit two sides of the guide portion 84 in the cutting direction Y, respectively. The cutter holder is selected from at least one of the first cutter holder 81 and the second cutter holder 82.

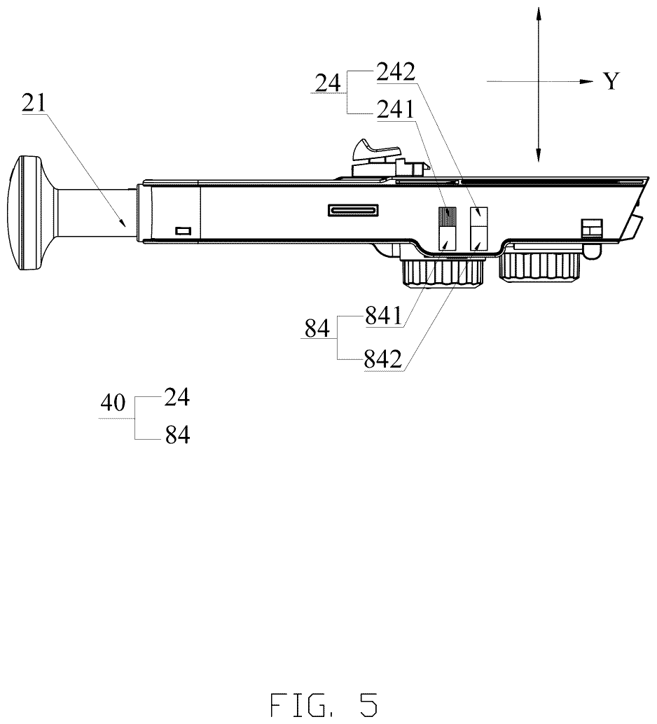

Referring to FIGS. 5, 10, 18 and 19, each of the second side wall 222 and the third side wall 223 of the cutting frame 22 is provided with a limiting portion 24, and both ends of each of the first cutter holder 81 and the second cutter holder 82 in the direction X is provided with a guide portion 84 received in the corresponding limiting portion 24, so that the second cutter 8 can stably move telescopically in the direction Z during adjustment to pass through or retract into at least one cutter feeding groove 62 on the cutting frame 22 accurately. At the same time, two inner side walls of the limiting portion 24 abut against and limit two sides of the guide portion 84 in the direction Y (the cutting direction of the second cutter 8), which can effectively prevent the second cutter 8 from shifting or shaking in the direction Y due to the resistance of food material during the cutting process, thereby improving the cutting precision and stability and avoiding damage to the first cutter 7 by the second cutter 8.

In one embodiment, when the cutter holder is located at the highest end of the stroke range of the second cutter 8 in the direction Z, an top wall of the limiting portion 24 in the direction Z abuts against and limits a top end of the guide portion 84 in the direction Z, and two inner side walls of the limiting portion 24 in the direction Y abut against and limit two sides of the guide portion 84 in the direction Y, respectively. When the cutter holder is located at the lowest end of the stroke range of the second cutter 8 in the direction Z, a bottom wall of the limiting portion 24 in the direction Z abuts against and limits a bottom end of the guide portion 84 in the direction Z, and two inner side walls of the limiting portion 24 in the direction Y abut against and limit two sides of the guide portion 84 in the direction Y, respectively. When the cutter holder is located at an extreme position in the direction Z, such as the lowest end or the highest end of the stroke range of the second cutter 8, the limiting portion 24 can limit the guide portion 84 on three sides to ensure the stability of the cutter holder during operation without easy shaking or tilting. When the cutter holder is at the middle position, the two inner side walls of the limiting portion 24 continuously abut against and limit the two sides of the guide portion 84 in the direction Y, ensuring that the second cutter 8 remains stable during the cutting process and does not shift in the direction Y due to external force or its own vibration, which greatly improves the reliability of the second cutter 8.

Further, end surfaces of the guide portion 84 on two sides in the direction Y are positioning planes 804, the positioning planes 804 is parallel to the axis O, and two inner side walls of the limiting portion 24 are parallel to the positioning planes 804.

In the present disclosure, referring to FIGS. 5, 10, 12 and 13, the limiting portion 24 includes a first limiting portion 241 and a second limiting portion 242, the guide portion 84 includes two first guide portions 841 disposed at both ends of the first cutter holder 81 in the direction X and two second guide portions 842 disposed at both ends of the second cutter holder 82 in the direction X. Each first guide portion 841 is received in the first limiting portion 241 and capable of reciprocating along the direction Z in the first limiting portion 241 for controlling the moving distance of the first cutting blades 812 in the direction Z. Each second guide portion 842 is received in the second limiting portion 242 and capable of reciprocating along the direction Z in the second limiting portion 242, thereby controlling the moving distance of the second cutting blades 822 in the direction Z.

In some embodiments, the guide portion 84 is a rectangular block, and the limiting portion 24 is a rectangular hole or a rectangular recess. In the present disclosure, the limiting portion 24 is a rectangular hole, so that the guide portion 84 can be exposed from the limiting portion 24, facilitating the user to know the moving position of the second cutter 8. In addition, by configuring the guide portion 84 as a rectangular block and the limiting portion 24 as a rectangular hole, the shape design is simple and regular, facilitating processing and manufacturing. At the same time, the rectangular structure can better realize a stable guiding and limiting function when cooperating with each other, ensuring that the guide portion 84 moves accurately along a predetermined direction in the limiting portion 24, further ensuring the stability and cutting precision of the second cutter 8 during the cutting process, and reducing problems such as shaking or shifting caused by an unreasonable structural shape.

In one embodiment, each guide portion 84 further includes an extension portion 85 extends from the guide portion 84 in the direction Z. The extension portion 85 is configured to increase the contact area between the guide portion 84 and the limiting portion 24, so that the limiting portion 24 abuts against and limits the guide portion 84 more stably. In addition, the extension portion 85 extends the length of the guide portion 84 in the direction Z, ensuring that when the guide portion 84 moves to the highest end of the stroke range of the second cutter 8 in the direction Z along the limiting portion 24, the tip portion 830 will not be too high above the tip portion of the first cutter 7 in the direction Z to cause an increase in cutting resistance, and when the guide portion 84 moves to the lowest end of the stroke range of the second cutter 8 in the direction Z in the limiting portion 24, the cutting blade 83 will not fall out of the cutter feeding groove 62 to cause difficulty in subsequent cutter feeding.

In the present disclosure, each of the first cutter holder 81 and the second cutter holder 82 further includes an inclined portion 87 located in the middle, an included angle β between the inclined portion 87 and the axis O is an acute angle, and guide portions 84 are disposed at both ends of the inclined portion 87, respectively.

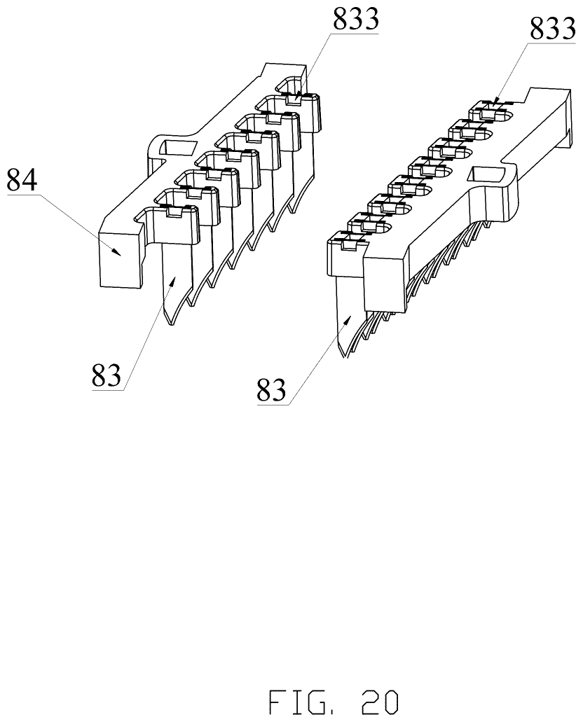

In the present disclosure, referring to FIG. 20, when the first cutter holder 81 and the second cutter holder 82 are engaged with each other, the plurality of first cutting blades 812 and the plurality of second cutting blades 822 are parallel to each other, and a distance D₄ between each first cutting blade 812 of the plurality of first cutting blades 812 and corresponding second cutting blade 822 of the plurality of second cutting blades 822 is equal to a distance D₃ between two adjacent second cutting blades 822 of the plurality of second cutting blades 822. That is, all the cutting blades are parallel to each other and arranged at equal intervals in the direction X, so that the shredded food material cut out have a uniform thickness.

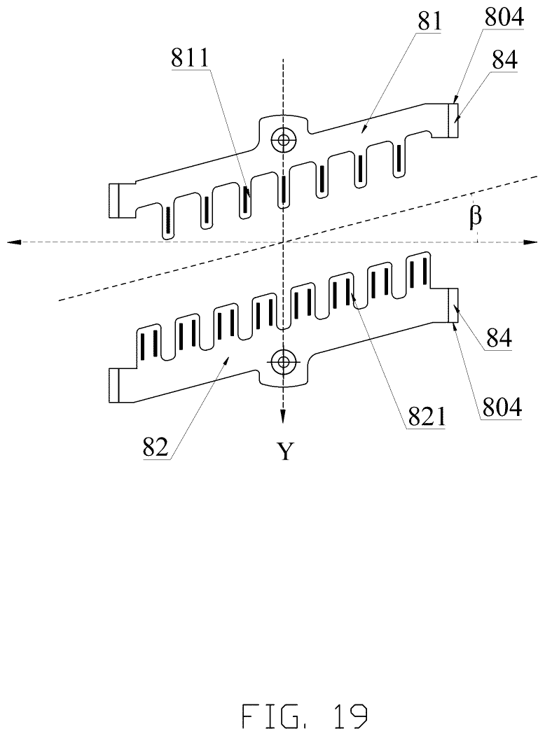

Referring to FIGS. 18 and 19, a plurality of cutting blades 83 are disposed on the inclined portion 87 of the cutter holder, such that the connecting line L₂ of the tip portions 830 of the cutting blades 83 is inclined relative to the axis O, which facilitates the cutting blades 83 to cut into the food material one by one during cutting and avoids excessive resistance on the second cutter 8 caused by all cutting blades cutting into the food material at the same time; the guide portions 84 are bent relative to the inclined portion 87, so that the positioning planes 804 of the guide portions 84 matching with the inner walls of the limiting portions 24 are parallel to the axis O, that is, the positioning planes 804 are perpendicular to the cutting direction (the direction Y), which prevents the cutter holder from shaking easily when stressed in the direction Y, is conducive to the telescopic movement of the cutter holder in the direction Z and the limiting and guiding of the cutter holder as a whole by the limiting portions 24, and is beneficial to maintaining the stability of the cutter holder.

In one embodiment, referring to FIG. 20, the cutter holder is integrally injection-molded, and the bottom ends of the cutting blades 83 are fixed in the cutter holder, with a positioning portion 833 exposed out of the cutter holder at the bottom end of each cutting blade 83. Before the injection molding of the cutter holder, the bottom ends of the cutting blades 83 are placed in the mold cavity, and the cutting blades 83 are fixed on the cutter holder through over molding with molten injection molding materials. This fixing method omits the traditional assembly process and significantly improves the production efficiency and connection reliability; the positioning portions 833 at the bottom ends of the cutting blades 83 can be positioned and matched with the tooling fixtures of the cutting blades 83 in the mold cavity to ensure that the cutting blades 83 are arranged as required, and the positioning portions of the cutting blades 83 are exposed relative to the bottom of the cutter holder after the formation of the cutter holder.

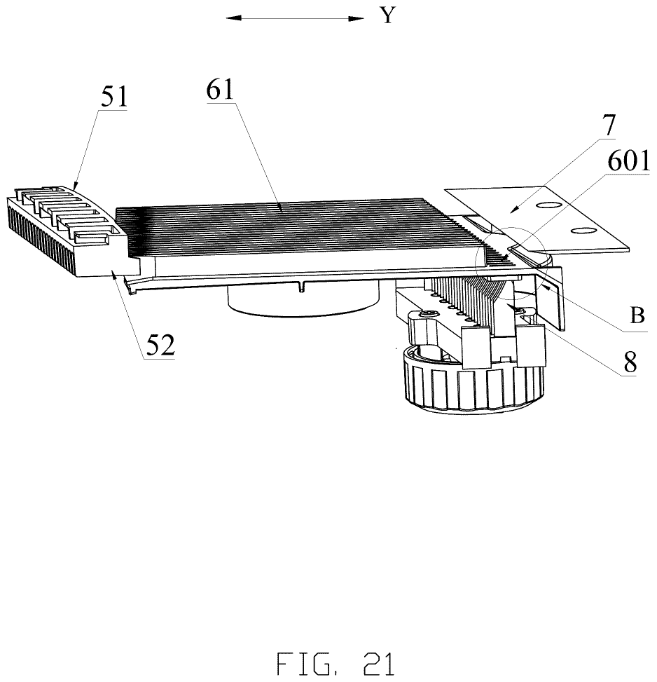

Referring to FIGS. 21 and 22, the adjusting member 6 is arranged on the cutting frame 22, and located downstream of the first cutter 7 and located a downstream of the second cutter 8 in the cutting direction, and movable relative to the first cutter 7 along the thickness direction to adjust the thickness of each cut.

The at least one cutter feeding groove 62 is defined on an end of the adjusting member 6 adjacent to the first cutter 7 and corresponds to at least one of the plurality of cutting blades 83. The at least one of the plurality of cutting blades 83 is movable from the storage position, then passes through the at least one cutter feeding groove 62 in the direction Z and toward the first cutter 7 to the first position at which the tip portion 830 of the at least one of the plurality of cutting blades 83 is beyond the first cutter 7 in the direction Z, thereby cooperating with the first cutter 7 to complete each cut. In this embodiment, a plurality of cutter feeding grooves 62 are defined at intervals at the end of the adjusting member 6 along the width direction, and the plurality of cutter feeding grooves 62 is corresponding to the plurality of cutting blades 83.

The cutting blades 83 are slidable in the cutter feeding grooves 62, the adjusting member 6 is movable relative to the cutting frame 22 in the direction Z, the second cutter 8 is also movable relative to the cutting frame 22 in the direction Z, and the adjusting member 6 and the second cutter 8 are relatively displaceable in the direction Z. When the adjusting member 6 is located at a highest end of a stroke range of the adjusting member 6 in the direction Z and the second cutter 8 is located at the lowest end of the stroke range of the second cutter 8 in the direction Z, that is the second cutter 8 is located at the storage position, upper sections of the cutting blades 83 are located in the cutter feeding groove 62, usually the tip portions 830 of the cutting blades 83 are located in the cutter feeding groove 62, and the tip portions 830 of the cutting blades 83 may also be exposed out of the cutter feeding groove 62 while the part immediately adjacent to the tip portions 830 is received in the cutter feeding groove 62.

In the present disclosure, since the tip portions 830 of the cutting blades 83 extend upward in the direction Z, the cutting blades 83 penetrate into the cutter feeding groove 62 from bottom to top. When the adjusting member 6 is located at the highest end of the stroke range of the adjusting member 6 in the direction Z and the second cutter 8 is located at the lowest end of the stroke range of the second cutter 8 in the direction Z, the adjusting member 6 is the farthest from the second cutter 8. Defining that at least a section of each the cutting blade 83 is located in the cutter feeding groove 62 in this extreme position state can ensure that the cutting blade 83 does not disengage from the cutter feeding groove 62 during the relative displacement of the adjusting member 6 and the second cutter 8, ensuring that the cutter feeding groove 62 guides and limits the movement of the cutting blades 83 in the direction Z, and the cutting blades 83 move stably in the direction Z.

When the cutting blades 83 are located at the storage position, the tip portions 830 of the cutting blades 83 are received in the cutter feeding groove 62, so that when adjusting the extension of the cutting blade 83, the problem that the tip portions 830 cannot be aligned with and pass through the cutter feeding groove 62 is avoided. At this time, the second cutter 8 does not participate in cutting the food material, and the first cutter 7 slices the food material. This can avoid unnecessary contact and collision between the cutting blades 83 and food material or other components, which not only protects the cutting blades 83 and prolongs its service life, but also improves the safety of the equipment in the non-cutting state.

Food material with different thicknesses can be cut by changing the distance between the surface of the adjusting member 6 and the first cutter 7 in the direction Z. That is, the distance between the first cutter 7 and the adjusting member 6 in the direction Z is the thickness of the food material cut by the blade assembly 31.

In the present embodiment, a plurality of cutter feeding grooves 62 arranged at intervals are defined at an end of the adjusting member 6 adjacent to the first cutter 7 along the width direction, each cutter feeding groove 62 is configured for a corresponding one of the plurality of cutting blades 83 to pass through. In this way, each cutting blade 83 can pass through the corresponding cutter feeding groove 62 along the thickness direction and move toward the first cutter 7 until the tip portion 830 of each cutting blade 83 protrudes from the outer surface of the first cutter 7, so as to cooperate with the first cutter 7 to cut food material.

In one embodiment, a cutter feeding area 601 is defined at an end of the adjusting member 6 adjacent to the first cutter 7 in the cutting direction (the direction Y), the cutter feeding area 601 is provided with the plurality of cutter feeding grooves 62 arranged at intervals along the direction X, a protruding portion 621 extends from a lower surface of the cutter feeding area 601, and each cutter feeding groove 62 penetrates the protruding portion 621 in the direction Z. The protruding portion 621 functions to deepen the cutter feeding groove 62 in the direction Z, improves the stability of the guiding and positioning effect of the cutter feeding groove 62 on the cutting blade 83, and further ensures that when the adjusting member 6 is located at the highest end of the stroke range of the adjusting member 6 in the direction Z and the second cutter 8 is located at the lowest end of the stroke range of the second cutter 8 in the direction Z, at least a part of the cutting blade (the tip portion 830 thereof) is located in the cutter feeding groove 62 to prevent the cutting blade 83 from disengaging from the cutter feeding groove. In one embodiment, the adjusting member 6 further includes a plurality of guide ribs 61 disposed on the upper surface of the adjusting member 6, and the plurality of guide ribs 61 extends along the direction Y and arranged at intervals along the direction X, the adjusting member 6 is movable in the direction Z to adjust the thickness of the cut food material, and the adjusting member 6 is capable of guiding and sliding fit with the ejection component 5 disposed on the inner wall of the second housing 1 of the food cutting device 100, the ejection component 5 being configured to push the cut food material to the discharging port.

Further, referring to FIG. 6, an upper end portion of the cutter feeding area 601 is connected with an bending plate 631 which is bent inwardly, the bending plate 631 covers and fits the upper end wall 233 of the mounting member 23 and is relatively slidable in the direction Z. Further, a middle section of the upper end wall 233 is a first arc-shaped wall 234, a middle section of the bending plate 631 is a second arc-shaped wall 632, and the second arc-shaped wall 632 covers and fits the first arc-shaped wall 234, which is convenient for providing sufficient space for mounting a knob described below, and the middle section of the bending plate 631 is a second arc-shaped wall 632 corresponding thereto, so as to provide guiding and limiting functions.

In one embodiment, the relative position of the adjusting member 6 with respect to the first cutter 7 in the direction Z is adjustable, the cutting frame 22 further includes a first blocking portion 226 arranged on inner sides of the second side wall 222 and the third side wall 223, and configured to prevent an end of the adjusting member 6 adjacent to the first cutter 7 from tilting upward in the direction Z. In the prior art, when it is necessary to cut food material into very thin slices or very fine shreds, the adjusting member 6 will be adjusted to the highest end of the stroke range of the adjusting member 6 in the direction Z, and the force during cutting will cause the upper end portion of the adjusting member 6 to tilt upward in the direction Z, resulting in uneven thickness of the cut food material. The arrangement of the first blocking portion 226 can effectively avoid the upward tilting of the upper end portion of the adjusting member 6 in the direction Z in the aforementioned situation, so that food material with uniform and thin thickness can be cut.

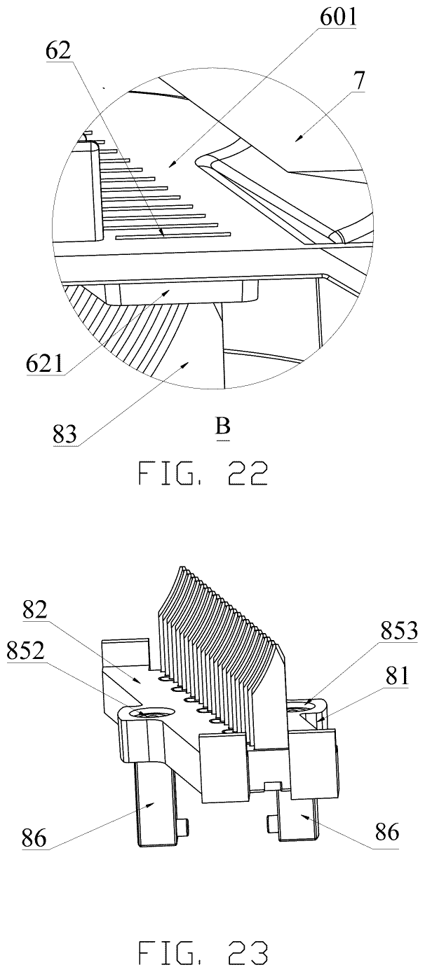

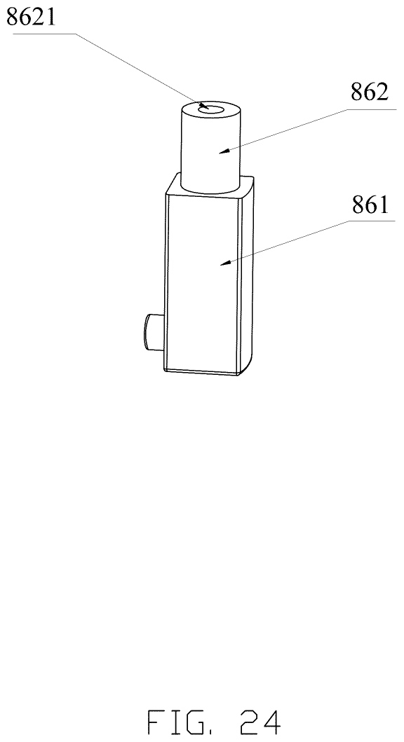

In one embodiment, with reference to FIGS. 6 and 23 to 24, the control assembly 33 includes a push rod 86, a first knob 232 and a second knob 87, the push rod 86 includes a lower section 861 connected to the mounting member 23 and a cylindrical section 862 located above the lower section 861. The cutter holder defines a circular through hole 852, and the cylindrical section 862 is insertable into the circular through hole 852, so that the push rod drives the cutter holder to move in the direction Z. Meanwhile, the cooperation between the cylindrical section and the circular through hole provides a small movable space for the cutter holder when the cutter holder slightly swings in the circumferential direction due to stress (the cutter holder will not swing greatly due to the cooperation of the limiting portion 24 and the guide portion 84), which can effectively avoid stress concentration, thereby reducing wear and prolonging the service life of the cutter holder. The lower section 861 of the push rod 86 may have a square cross-section (a square column), so that the mounting member 23 limits the axial and circumferential directions of the lower section 861, ensuring the stability of the push rod 86 during movement without deviation or shaking, thereby ensuring the accuracy of the movement of the cutter holder and making the entire blade assembly 31 more reliable and stable during operation.

Further, the cylindrical section 862 includes a screw hole 8621 configured for a screw to be screwed into, and a counterbore 853 for accommodating a head of the screw is disposed at an upper end of the circular through hole 852. After the screw is screwed into the screw hole 8621 of the cylindrical section 862, the head of the screw is received and limited in the counterbore 853 at the upper end of the circular through hole 852, so that the push rod 86 cannot be disengaged from the circular through hole 852 downward. This design also prevents the screw from protruding from the surface of the cutter holder, avoiding interference and collision between the screw and the cutting frame or other components during the movement of the cutter holder, ensuring that the cutter holder can move smoothly in the direction Z and improving the fluency and stability of the overall operation of the second cutter 8. At the same time, this connection mode also facilitates the installation and disassembly of the push rod and the cutter holder; when it is necessary to maintain the second cutter 8 or replace components, the push rod can be separated from the cutter holder only by unscrewing the screw, with simple and fast operation.

The first knob 232 is arranged on the mounting member 23, the receiving groove 231 is disposed on the mounting member 23, and the lower section 861 is mounted in the receiving groove 231. Rotating the first knob 232 can drive the push rod 86, the first cutter holder 81 and the second cutter holder 82 to move along the direction Z, thereby controlling the moving distance of each cutting blade 83 in the thickness direction (the direction Z), and thus controlling the position of the second cutter 8 relative to the first cutter 7, so as to better ensure that the food material can be cut off in a controlled manner.

The second knob 87 is assembled on the mounting member 23 and coupled with the adjusting member 6, and is configured to control the movement of the adjusting member 6 in the direction Z to control the cutting thickness of the food material. For example, when a greater thickness of food material is required, rotating the second knob 87 clockwise drives the adjusting member 6 to slide relative to the housing 1 in a direction away from the first cutter 7, and the distance between the adjusting member 6 and the first cutter 7 becomes larger, at which time the food material can be cut into thicker slices. on the contrary, rotating the second knob 87 counterclockwise drives the adjusting member 6 to slide relative to the second housing 1 in a direction close to the first cutter 7, and the distance between the adjusting member 6 and the first cutter 7 becomes smaller, at which time the food material can be cut into thinner slices. In one embodiment of the food cutting device 100 of the present disclosure, the food cutting device 100 includes: a base (the second housing 1); a cutting frame 22 movable relative to the base along a first direction (the direction Y); a first cutter 7 arranged on the cutting frame 22, a component of an extending direction of a cutting edge of the first cutter 7 is in a second direction (the direction X) which is perpendicular to the first direction (the direction Y); a second cutter 8 arranged on the cutting frame 22 and located downstream of the first cutter 7 in the first direction (the direction Y), and an adjusting member 6 arranged on the cutting frame 22 and located downstream of the first cutter 7 and located downstream of the second cutter 8 in the cutting direction, and movable relative to the first cutter 7 along the third direction (the direction Z) thereby adjusting a thickness of each cut. The second cutter 8 includes a plurality of cutting blades 83 spaced apart along the second direction (the direction X), a blade face of each cutting blade 83 extends along a third direction (the direction Z) which is perpendicular to the first direction (the direction Y) and the second direction (the direction X), each cutting blade 83 is movable along the third direction (the direction Z) between a first position and a second position; the adjusting member 6 includes at least one cutter feeding groove corresponding to at least one of the plurality of cutting blades 83, the at least one of the plurality of cutting blades 83 is movable from the second position, then passes through the at least one cutter feeding groove in the third direction (the direction Z) and toward the first cutter 7 to the first position at which a tip portion 830 of the at least one of the plurality of cutting blades 83 is beyond the first cutter 7 in the third direction (the direction Z). It can be seen that it can better ensure that the food material can be cut off in a controlled manner.

In an embodiment, the food cutting device 100 includes a housing (the second housing 1); a cutting frame 22 attached to the housing and movable relative to the housing along a first direction (the direction Y); a first cutter 7 attached to the cutting frame 22 and movable together with the cutting frame 22, the first cutter 7 having a cutting edge which has at least a component extending along a second direction (the direction X) which is perpendicular to the first direction (the direction Y); a second cutter 8 attached to the cutting frame 22 and located downstream of the first cutter 7 in the cutting direction, an adjusting member 6 attached to the cutting frame 22 and located downstream of the first cutter 7 and located downstream of the second cutter 8 in the cutting direction, and movable relative to the first cutter 7 along the third direction (the direction Z), thereby adjusting a thickness of each cut. The second cutter 8 including a plurality of cutting blades 83 spaced apart along the second direction (the direction X), wherein a blade face of each cutting blade 83 has at least a component extending along a third direction (the direction Z) which is perpendicular to the first direction (the direction Y) and the second direction (the direction X), the adjusting member 6 includes at least one cutter feeding groove which at least a portion of the plurality of cutting blades 83 is capable of passing through; and a limiting mechanism cooperating with the second cutter 8 and configured to limit a moving distance of each cutting blade 83 in the third direction (the direction Z), wherein each cutting blade 83 is movable between a first position at which the second cutter 8 cooperates with the first cutter 7 for cutting food material and a second position at which the second cutter 8 does not cut the food material. It can be seen that the arrangement of the limiting assembly 40 controls the moving distance of the cutting blade 83 in the third direction (the direction Z), thereby controlling the position of the second cutter 8 relative to the first cutter 7, and thus better ensuring that the food material can be cut off in a controlled manner.

The present disclosure is not limited to the above embodiments, and various changes can be made within the scope shown in the claims. Embodiments obtained by appropriately combining the technical solutions disclosed in different embodiments are also included in the technical scope of the present disclosure. Furthermore, new technical features can be formed by combining the technical means disclosed in each embodiment respectively.

What is claimed is:

1. A food cutting device comprising:
a base;
a cutting frame movable relative to the base along a first direction;
a first cutter arranged on the cutting frame, a component of an extending direction of a cutting edge of the first cutter is in a second direction which is perpendicular to the first direction;
a second cutter arranged on the cutting frame and located downstream of the first cutter in the first direction, the second cutter comprising a plurality of cutting blades spaced apart along the second direction, wherein a blade face of each cutting blade extends along a third direction which is perpendicular to the first direction and the second direction, each cutting blade is movable along the third direction between a first position and a second position; and
an adjusting member arranged on the cutting frame and located downstream of the first cutter and located downstream of the second cutter in the cutting direction, and movable relative to the first cutter along the third direction thereby adjusting a thickness of each cut, wherein the adjusting member comprises at least one cutter feeding groove corresponding to at least one of the plurality of cutting blades,
the at least one of the plurality of cutting blades is movable from the second position, then passes through the at least one cutter feeding groove in the third direction and toward the first cutter to the first position at which a tip portion of the at least one of the plurality of cutting blades is beyond the first cutter in the third direction.

2. The food cutting device according to claim 1, wherein
in a case that each of the plurality of cutting blades is located at the first position, a gap D₂ in the third direction is formed between the tip portion of the at least one of the plurality of cutting blades and a tip portion of the first cutter, wherein the gap D₂ satisfies 0.6 mm≤D₂≤1.8 mm.

3. The food cutting device according to claim 1, wherein a gap D₁ in the first direction is formed between a tip portion of the first cutter and the tip portion of the at least one of the plurality of cutting blades, wherein the gap D₁ satisfies 1.0 mm≤D₁≤4.6 mm.

4. The food cutting device according to claim 1, wherein each cutting blade comprises a front cutting edge and a rear cutting edge connected to the front cutting edge, when the second cutter is in the first position, the front cutting edge is disposed on a side facing away from the first cutter, the rear cutting edge is disposed on a side facing toward the first cutter, and the length of the front cutting edge is greater than a length of the rear cutting edge.

5. The food cutting device according to claim 1, wherein an imaginary connecting line defined by connecting the tip portions of the plurality of cutting blades is a straight line L₂, a projection of an outer edge of the cutting edge of the first cutter in the third direction is a straight line L₁, L₁ is parallel to L₂, and an included angle formed between L₁ and the second direction is an acute angle.

6. The food cutting device according to claim 1, wherein each cutting blade is movable away from the first cutter until the tip portion is received in the cutter feeding groove.

7. The food cutting device according to claim 1, further comprising a limiting assembly configured to limit a moving distance of each cutting blade in the third direction.

8. The food cutting device according to claim 7, wherein the second cutter further comprises a cutter holder, the plurality of cutting blades is arranged on the cutter holder at intervals,
the limiting assembly comprises at least one guide portion and at least one limiting portion cooperating with the at least one guide portion, each of the at least one guide portion is disposed at the cutter holder, each of the at least one limiting portion is disposed on the cutting frame;
the at least one guide portion is received in the at least one limiting portion and slidable along the third direction,
two inner side walls of the limiting portion abut against and limit two sides of the guide portion in the cutting direction, respectively.

9. The food cutting device according to claim 8, wherein in a case that the tip portion of each cutting blade protrudes from the tip portion of the first cutter to a highest end of a stroke range of the second cutter in the third direction, a top wall of the limiting portion in the third direction abuts against and limits a top end of the guide portion in the third direction, and the two inner side walls of the limiting portion in the cutting direction abut against and limit two sides of the guide portion in the cutting direction, respectively.

10. The food cutting device according to claim 8, wherein in a case that the tip portion of each cutting blade is received in the cutter feeding groove to a lowest end of a stroke range of the second cutter, a bottom wall of the limiting portion in the third direction abuts against and limits a bottom end of the guide portion in the third direction, and the two inner side walls of the limiting portion in the first direction abut against and limit two sides of the guide portion in the first direction, respectively.

11. The food cutting device according to claim 1, wherein the second cutter further comprises a cutter holder, the plurality of cutting blades is arranged on the cutter holder at intervals; and wherein
the food cutting device further comprises a mounting member disposed on the cutting frame and an control assembly configured to drive the cutter holder to move along the third direction, the control assembly including a push rod, wherein the push rod comprises a lower section connected to the mounting member and a cylindrical section located above the lower section, and the cutter holder defines a circular through hole, the cylindrical section is insertable into the circular through hole.

12. The food cutting device according to claim 1, wherein the second cutter further comprises a first cutter holder and a second cutter holder, the first cutter holder comprises a plurality of first protrusions arranged at intervals along the second direction and a plurality of first cutting blades, each first protrusion is provided with one first cutting blade;
the second cutter holder comprises a plurality of second protrusions arranged at intervals along the second direction and a plurality of second cutting blades, each second protrusion is provided with at least two second cutting blades;
the first cutter holder and the second cutter holder are engaged with each other via a concave-convex engagement of the plurality of first protrusions and the plurality of second protrusions and are slidable relative to each other in the third direction.

13. The food cutting device according to claim 12, wherein in a case that the first cutter holder and the second cutter holder are engaged with each other, the plurality of first cutting blades and the plurality of second cutting blades are parallel to each other, and a distance D₄ between each first cutting blade of the plurality of first cutting blades and a corresponding second cutting blade of the plurality of second cutting blades is equal to a distance D₃ between two adjacent second cutting blades of the plurality of second cutting blades.

14. The food cutting device according to claim 1, wherein the adjusting member defines a cutter feeding area at the end of the adjusting member adjacent to the first cutter in the first direction; the adjusting member further comprises a protruding portion extending from a lower surface of the cutter feeding area, wherein
each cutter feeding groove penetrates the protruding portion in the third direction.

15. The food cutting device according to claim 1, wherein the cutting frame comprises a blocking portion configured to prevent an end of the adjusting member adjacent to the first cutter from tilting upward in the third direction.

16. A food cutting device, comprising:
a housing;
a cutting frame attached to the housing and movable relative to the housing along a first direction;
a first cutter attached to the cutting frame and movable together with the cutting frame, the first cutter having a cutting edge which has at least a component extending along a second direction which is perpendicular to the first direction;
a second cutter attached to the cutting frame and located downstream of the first cutter in the cutting direction, the second cutter comprising a plurality of cutting blades spaced apart along the second direction, wherein a blade face of each cutting blade has at least a component extending along a third direction which is perpendicular to the first direction and the second direction;
an adjusting member attached to the cutting frame and located downstream of the first cutter and located downstream of the second cutter in the cutting direction, and movable relative to the first cutter along the third direction, thereby adjusting a thickness of each cut, wherein the adjusting member comprises at least one cutter feeding groove which at least a portion of the plurality of cutting blades is capable of passing through; and
a limiting mechanism cooperating with the second cutter and configured to limit a moving distance of each cutting blade in the third direction, wherein each cutting blade is movable between a first position at which the second cutter cooperates with the first cutter for cutting food material and a second position at which the second cutter does not cut the food material.

17. The food cutting device according to claim 16, wherein in a case that each cutting blade is located at the first position, a tip portion of each cutting blade protrudes beyond a tip portion of the first cutter in the third direction.

18. The food cutting device according to claim 17, wherein in the case that each cutting blade is located at the first position, a gap D₂ in the third direction is formed between the tip portion of the cutting blade and the tip portion of the first cutter, wherein the gap D₂ satisfies 0.6 mm≤D₂≤1.8 mm.

19. The food cutting device according to claim 16, wherein a gap D₁ in the first direction is formed between the tip portion of the first cutter and the tip portion of each cutting blade, wherein the gap D₁ satisfies 1.0 mm≤D₁≤4.6 mm.

20. The food cutting device according to claim 16, wherein in a case that each cutting blade moves to a lowest end of a stroke range of the second cutter in the third direction, each cutting blade is located at the second position, and the tip portion of each cutting blade is received in a corresponding one of the at least one cutter feeding groove.

21. The food cutting device according to claim 16, wherein the second cutter further comprises a cutter holder, the plurality of cutting blades is arranged on the cutter holder at intervals; and wherein
the limiting mechanism comprises at least one guide portion for guiding the second cutter to move in the third direction and at least one limiting portion corresponding to the at least one guide portion for restrict a movement of the second cutter in the third direction, each of the at least one guide portion is disposed at an end of the cutter holder in the second direction, each of the at least one limiting portion is disposed on a side wall of the cutting frame; and
two inner side walls of the limiting portion abut against and limit two sides of the guide portion in the first direction, respectively.

22. The food cutting device according to claim 21, wherein in a case that the plurality of cutting blades move to the first position, an end wall of the limiting portion in the third direction abuts against and limits an end of the guide portion in the third direction, and the two inner side walls of the limiting portion in the first direction abut against and limit two sides of the guide portion in the first direction, respectively.

23. The food cutting device according to claim 16, wherein the second cutter further comprises a first cutter holder and a second cutter holder, the first cutter holder comprises a plurality of first protrusions arranged at intervals along the second direction and a plurality of first cutting blades, each first protrusion is provided with one of the first cutting blades;
the second cutter holder comprises a plurality of second protrusions arranged at intervals along the second direction and a plurality of second cutting blades, each second protrusion is provided with at least two second cutting blades;
the first cutter holder and the second cutter holder are engaged with each other via a concave-convex engagement of the plurality of first protrusions and the plurality of second protrusions and are slidable relative to each other in the third direction.
